(19) United States
(12) Patent Application Publication
(10) Pub. No.: US 2015/0301672 A1
(43) Pub. Date: Oct. 22, 2015

(54) DISPLAY APPARATUS AND METHOD OF CONTROLLING THE SAME

(71) Applicant: Samsung Display Co., Ltd., Yongin-City (KR)

(72) Inventors: Sang-Ho Kim, Yongin-City (KR); Byeong-Hwa Choi, Yongin-City (KR); Jae-Woo Bae, Yongin-City (KR); Young-Sang Ha, Yongin-City (KR)

(21) Appl. No.: 14/495,180

(22) Filed: Sep. 24, 2014

(30) Foreign Application Priority Data
Apr. 18, 2014 (KR) 10-2014-0046937

(51) Int. Cl. G06F 3/041; G09G 5/10; G06F 1/16

(52) U.S. Cl. CPC G06F 3/0414; G06F 1/1652; G06F 3/041; G09G 5/10; G06F 2203/04102; G09G 2380/02

(57) ABSTRACT

A flexible display apparatus includes: a flexible display panel which operates in a plane mode or a curved mode; a sensor unit which measures a direction, a location or a degree of a curvature of the flexible display panel; and a brightness control unit which controls brightness of an area of the flexible display panel based on the direction, the location or the degree of the curvature of the flexible display panel.

This application claims priority to Korean Patent Application No. 10-2014-0046937, filed on Apr. 18, 2014, and all the benefits accruing therefrom under 35 U.S.C. §119, the content of which in its entirety is herein incorporated by reference.

### BACKGROUND

1. Field

One or more embodiments of the invention relate to a display apparatus including a flexible display panel that implements a plane mode and a curved mode, and more particularly, to a display apparatus that determines the curvature of panel areas based on a degree of curvature of a display panel.

2. Description of the Related Art

A mobile electronic device has become widely used. The mobile electronic device may be a small electronic device such as a mobile phone, or a tablet personal computer (“PC”) that has recently become popular.

Such a mobile electronic device typically includes a display apparatus to support various functions and provide a user with visual information such as images or moving pictures. As sizes of components for driving the display apparatus are decreased, the importance of the display apparatus in each electronic device increases. In addition, a flexible flat display apparatus has been developed.

### SUMMARY

In exemplary embodiments of the invention, a degree of curvature of a flexible display apparatus is measured by a sensor to improve the visibility thereof, and the brightness of each area of the flexible display apparatus is controlled based on the degree of curvature.

In an exemplary embodiment of the invention, when the degree of curvature of the flexible display apparatus exceeds a certain degree, the brightness of the flexible display apparatus is automatically.

According to one or more exemplary embodiments of the invention, a flexible display apparatus includes: a flexible display panel which operates in a plane mode or a curved mode; a sensor unit which measures a direction, a location or a degree of a curvature of the flexible display panel; and a brightness control unit which controls brightness of an area of the flexible display panel based on the direction, the location or the degree of the curvature of the flexible display panel.

In an exemplary embodiment, the brightness control unit may obtain a distance between a user and the area of the flexible display panel and may control the brightness of the area of the flexible display panel based on the distance.

In an exemplary embodiment, the flexible display panel may be divided into a plurality of sub-areas, and the brightness control unit may control the brightness of each of the plurality of sub-areas based on the degree or direction of the curvature.

In an exemplary embodiment, when the direction of the curvature of the flexible display panel is a direction away from a user, the brightness control unit may increase a brightness of a curved area of the flexible display panel substantially in proportion to the degree of the curvature corresponding to the curved area.

In an exemplary embodiment, when the direction of the curvature of the flexible display panel is a direction toward a user, the brightness control unit may decrease a brightness of a curved area of the flexible display panel substantially in proportion to the degree of the curvature corresponding to the curved area.

In an exemplary embodiment, the brightness control unit may calculate a distance between the user and the area of the flexible display panel based on the direction, the location and the degree of the curvature, and as the distance between the user and the area of the flexible display panel increases, the brightness control unit may decrease the brightness of the area based on the calculated distance.

In an exemplary embodiment, the flexible display panel may include a curved display panel or a folded display panel.

In an exemplary embodiment, the flexible display panel may include a large-sized display panel or a user terminal display panel.

In an exemplary embodiment, when the flexible display panel curves along a vertical axis, pixels of the flexible display panel arranged on the vertical axis may have brightness substantially the same as each other, and when the flexible display panel curves along a horizontal axis, the pixels of the flexible display panel arranged on the horizontal axis may have brightness substantially the same as each other.

In an exemplary embodiment, a fixed folding line is defined in the flexible display panel, and a sensor of the sensor unit may be disposed in the folding line.

In an exemplary embodiment, when the degree of the curvature is equal to or greater than a predetermined value, an entire area of the flexible display panel may have a minimum brightness.

In an exemplary embodiment, when the flexible display panel is in the plane mode, an entire area of the flexible display panel may have a same brightness.

In an exemplary embodiment, the flexible display panel may include a liquid crystal display or an organic light-emitting device.

In an exemplary embodiment, the sensor unit may include a sensor, and the sensor may be a transparent and flexible sensor.

In an exemplary embodiment, the flexible display panel may be bent by an external force or a remote control.

According to one or more exemplary embodiments of the invention, a method of controlling a flexible display apparatus includes: bending a flexible display panel using a force or based on a remote control; measuring a direction, a location or a degree of a curvature of the flexible display panel via a sensor unit; and controlling brightness of an area of the flexible display panel based on the direction, the location or the degree of the curvature.

In an exemplary embodiment, the controlling the brightness may include: obtaining a distance between a user and the area of the flexible display panel based on the direction, the location or the degree of the curvature; and controlling brightness of the area of the flexible display panel based on the distance.

In an exemplary embodiment, the controlling the brightness may include: dividing the flexible display panel into a plurality of sub-areas; and controlling brightness of each of the plurality of sub-areas based on the degree or the direction of the curvature of the flexible display panel.

In an exemplary embodiment, the controlling the brightness may include increasing brightness of a curved area of the flexible display panel substantially in proportion to the degree of the curvature corresponding to the curved area.

In an exemplary embodiment, the controlling the brightness may include decreasing a curved area of the flexible display panel substantially in proportion to the degree of the curvature corresponding to the curved area.

### BRIEF DESCRIPTION OF THE DRAWINGS

These and/or other features of the invention will become apparent and more readily appreciated from the following description of exemplary embodiments, taken in conjunction with the accompanying drawings, in which:

FIGS. 1A through 1C are schematic perspective views of a plane mode and a curved mode of exemplary embodiments of a display apparatus, respectively, according to the invention;

FIGS. 2A and 2B illustrate a distance between a user and an exemplary embodiment of a display apparatus in a plane mode or a curved mode, according to the invention;

FIG. 3 is a cross-sectional view taken along line I-I′ of FIG. 1A;

FIG. 4 is an enlarged cross-sectional view of a portion II of FIG. 3;

FIG. 5 is a schematic diagram showing an exemplary embodiments of a shape deformation unit of FIG. 3;

FIG. 6 is a block diagram of a display apparatus according to the invention;

FIG. 7 is a block diagram showing the brightness control of areas of an exemplary embodiment of a flexible display panel;

FIGS. 8A through 8C are diagrams showing the brightness control in exemplary embodiments of a flexible display panel, according to the invention;

FIGS. 9A through 9C are diagrams showing the brightness control in exemplary embodiments of a flexible display panel, according to the invention; and

FIG. 10 is a diagram showing the brightness control in another alternative exemplary embodiment of a flexible display panel, according to the invention.

### DETAILED DESCRIPTION

The invention now will be described more fully hereinafter with reference to the accompanying drawings, in which various embodiments are shown. This invention may, however, be embodied in many different forms, and should not be construed as limited to the embodiments set forth herein. Rather, these embodiments are provided so that this disclosure will be thorough and complete, and will fully convey the scope of the invention to those skilled in the art. Like reference numerals refer to like elements throughout.

It will be understood that when an element is referred to as being “on” another element, it can be directly on the other element or intervening elements may be therebetween. In contrast, when an element is referred to as being “directly on” another element, there are no intervening elements present.

It will be understood that, although the terms “first,” “second,” “third” etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, “a first element,” “component,” “region,” “layer” or “section” discussed below could be termed a second element, component, region, layer or section without departing from the teachings herein.

The terminology used herein is for the purpose of describing particular embodiments only and is not intended to be limiting. As used herein, the singular forms “a,” “an,” and “the” are intended to include the plural forms, including “at least one,” unless the content clearly indicates otherwise. “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower,” can therefore, encompasses both an orientation of “lower” and “upper,” depending on the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within ±30%, 20%, 10%, 5% of the stated value.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the disclosure, and will not be interpreted in an idealized or overly formal sense unless expressly so defined herein.

Exemplary embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the claims.

Hereinafter, exemplary embodiments of the invention will be described in detail with reference to the accompanying drawings.

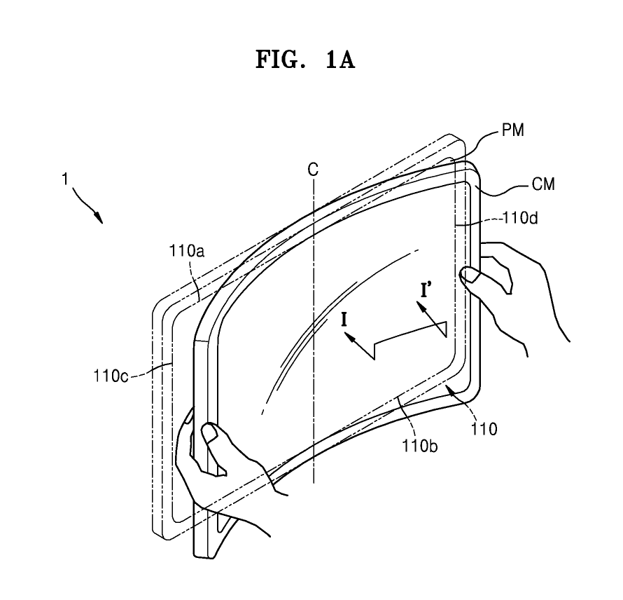

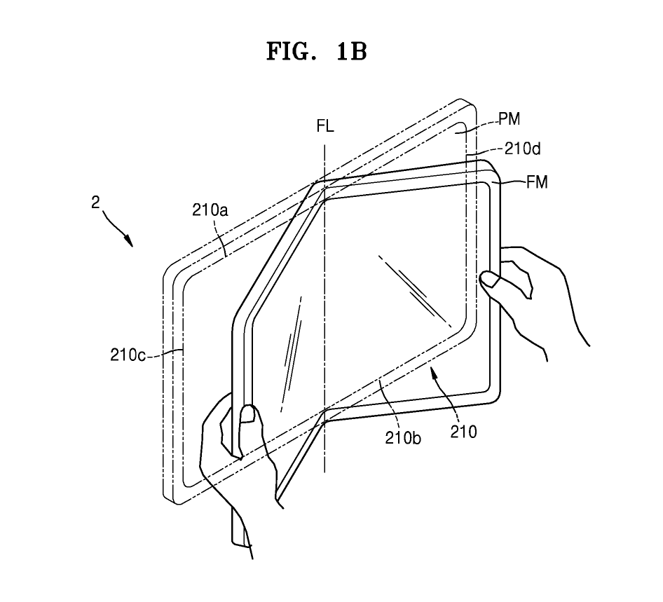

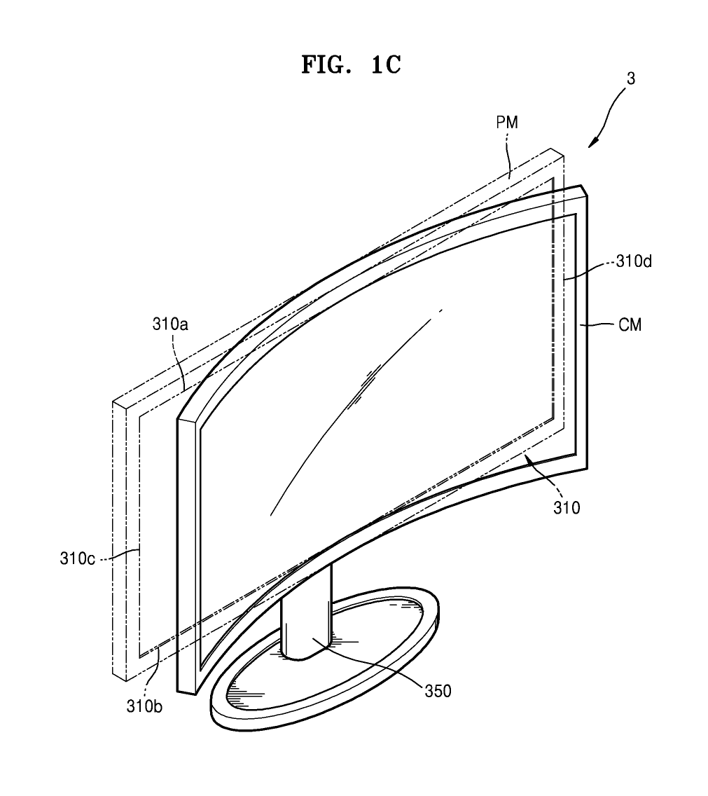

FIGS. 1A through 1C are schematic perspective views of a plane mode (“PM”) and a curved mode (“CM”) of exemplary embodiments of a display apparatus 1, 2 and 3, respectively, according to the invention.

Exemplary embodiments of the display apparatus 1, 2 and 3 each include a flexible display panels 110, 210 or 310 configured to selectively implement the PM, the CM, or a folded mode FM.

Referring to FIG. 1A, an exemplary embodiment of the display apparatus 1 may be a user terminal that is curved. The display apparatus 1 includes the flexible display panel 110 that is curved and may be any type of apparatuses carried by a user. In one exemplary embodiment, for example, the display apparatus 1 may be a smartphone, a tablet personal computer (“PC”), or the like. In an exemplary embodiment, the flexible display panel 110 may display a home screen, a main page of an installed application, etc. of the user terminal. The flexible display panel 110 outputs visual information, which may be activated based on a program executed in the display apparatus 1, to a user via a front screen of the flexible display panel 110. In one exemplary embodiment, for example, the flexible display panel 110 is a flexible display and may be a flexible organic light-emitting diode (“OLED”) display, a flexible liquid crystal display (“LCD”), or the like.

As illustrated in FIG. 1A, the display apparatus 1 maintains the PM and then may change into the CM by being curved due to external force such as force applied by the user. The flexible display panel 110 may be curved in various directions.

The flexible display panel 110 of the display apparatus 1 includes first and second long sides 110a and 110b that extend substantially parallel to each other in the PM and first and second short sides 110c and 110d that extend substantially perpendicularly to the first and second long sides 110a and 110b. In such an embodiment, the flexible display panel 110 may have a rectangular form having four edges. In an exemplary embodiment, as shown in FIG. 1A, the flexible display panel 110 may include a border or bezel having a predetermined width, but not being limited thereto. In an alternative exemplary embodiment, the flexible display panel 110 may be a borderless or baseless display.

A mode of the flexible display panel 110 of the display apparatus 1 may be changed from the PM into the CM due to the external force such as the force applied by the user as illustrated in FIG. 1A. In such an embodiment, a degree of curvature of the flexible display panel 110 may be increased from a center of the flexible display panel 110 to at least one edge based on strength of the external force. In an exemplary embodiment, the degree of curvature of the flexible display panel 110 may be substantially symmetrically increased from the center of the flexible display panel 110 to both edges that are vertically arranged, that is, to the first and second short sides 110c and 110d. In such an embodiment, after a point of inflection is formed at the center of the flexible display panel 110 in the CM, the degree of curvature is decreased from the first short side 110c to the center of the flexible display panel 110 and increased from the center of the flexible display panel 110 to the second short side 110d. In an exemplary embodiment, the degree of curvature may be defined based on a distance between the first and second short sides 110c and 110d in the PM and the CM. In an alternative exemplary embodiment, the degree of curvature may be increased from the first long sides 110a and 110b to the center of the flexible display panel 110.

In an exemplary embodiment, as shown in FIG. 1A, the flexible display panel 110 may be curved in a direction substantially parallel to the first and second short sides 110c and 110d, but is not limited thereto. Alternately, the flexible display panel 110 may be curved in a direction substantially parallel to the first and second long sides 110a and 110b, or the flexible display panel 110 may be curved in another direction that is not parallel to four edges of the flexible display panel 110.

FIG. 1B is a view of an alternative exemplary embodiment of the display apparatus 2 according to the invention.

In an exemplary embodiment, as shown in FIG. 1B, the display apparatus 2 may be a foldable user terminal. In such an embodiment, the flexible display panel 210 of the display apparatus 2 is folded along a folding line FL instead of being entirely bent. In such an embodiment, the folding line FL is defined to be substantially parallel to first and second short sides 210c and 210d, but may be substantially parallel to first and second long sides 210a and 210b. The display apparatus 2 may be selectively in the PM or the FM. In such an embodiment, the folding line FL is at a center C of the flexible display panel 210, but is not limited thereto. When external force is applied to the flexible display panel 210 in the PM by the user, the flexible display panel 210 may be curved along the folding line FL. A curved angle of the flexible display panel 210 may be substantially proportional to the external force.

FIG. 1C is a view of another alternative exemplary embodiment of the display apparatus 3 according to the invention.

In an exemplary embodiment, as shown in FIG. 1C, the display apparatus 3 may further include a support 350. The display apparatus 3 illustrated in FIG. 1C may be a television or a monitor that has a large size, that is, the display apparatus 3 may be a large-sized display panel. Herein, the large size means a size greater than a predetermined size of a display panel typically used in a mobile display device. In such an embodiment, the display apparatus 3 may not be a mobile terminal, and the display apparatus 3 may further include the support 350 for supporting the flexible display panel 310.

The display apparatus 3 includes the flexible display panel 310 that is curved and including first and second long sides 310a and 310b and first and second short sides 310c and 310d, and the flexible display panel 310 may be selectively in the PM or the CM. In such an embodiment, a shape of the display apparatus 3 may be changed by remote control without external force that is directly and physically applied to the display apparatus 3.

Herein, an exemplary embodiment of the display apparatus 1 shown in FIG. 1A will be mainly described in greater detail. The exemplary embodiments of the display apparatus 2 or 3 shown in FIG. 1B or 1C may be substantially the same as the exemplary embodiment of the display apparatus shown in FIG. 1A. The same or like elements shown in FIGS. 1B and 1C have been labeled with the same reference characters as used to describe the exemplary embodiments of the display apparatus shown in FIG. 1A, and any repetitive detailed description thereof will hereinafter be omitted or simplified.

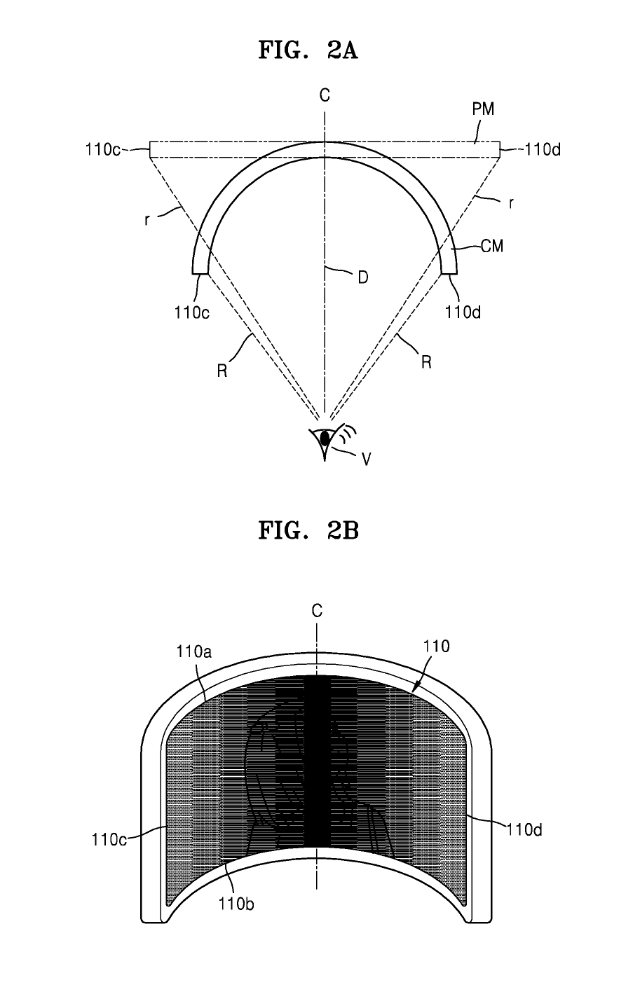

FIGS. 2A and 2B illustrate a distance between a user and an exemplary embodiment of the display apparatus 1 in the PM or the CM, according to the invention.

FIGS. 2A and 2B illustrate an exemplary embodiment of the display apparatus 1 as shown in FIG. 1A, but the display apparatus shown in FIGS. 2A and 2B may be the exemplary embodiments of the display apparatus 2 and 3 shown in FIGS. 1B and 1C. As illustrated in FIG. 2A, a size of the display apparatus 1 is exaggerated in comparison with a size of a viewer V for better understanding of the invention. However, the size of the display apparatus 1 may be similar to a size of a user terminal display panel.

When the flexible display panel 110 extends lengthwise in a horizontal direction and the viewer V is positioned on an extension line of the center C of the flexible display panel 110, a distance r between the viewer V and the first and second short sides 110c and 110d in the PM is smaller than a distance R between the viewer V and the first and second short sides 110C and 110D in the CM. However, a distance D between the viewer V and the center of the flexible display panel 110 is the same regardless of a mode of the flexible display panel 110.

Therefore, in an exemplary embodiment, the display apparatus 1 including the flexible display panel 110 may have a distance difference because a distance between the viewer V and each area of the flexible display panel 110 become different from each other due to the curvature, unlike a conventional display apparatus that is constantly in the PM.

In the conventional PM, the brightness of the flexible display panel 110, which is recognized by the user, is hardly different even though the brightness of pixels in each area of the flexible display panel 110 is the same because a difference of the distance r between the viewer V and the first and second short sides 110c and 110d and the distance D between the viewer V and the flexible display panel 110 may not be great enough to allow the user to recognize a brightness difference.

However, in an exemplary embodiment, when the center C of the flexible display panel 110 is curved to be far from the user, the distance D becomes greater than the distance R. Accordingly, quality of view of the user may be diminished due to the distance difference. That is, the user may recognize that the brightness of pixels around the center C of the flexible display panel 110 may be lower than that of pixels around the edges.

FIG. 2B shows an image displayed on a front screen of an exemplary embodiment of the flexible display panel 110. FIG. 2B illustrates the brightness of the image, which is recognized by the user, when all pixels of the flexible display panel 110 have the same brightness.

Referring to FIG. 2B, an exemplary embodiment of the flexible display panel 110 may be curved such that the first and second short sides 110c and 110d may be close to the user and the center of the flexible display panel 110 may be far from the user due to the curvature of the flexible display panel 110. When the flexible display panel 110 is curved as described above, the user may recognize that the brightness gradually decreases from the first and second short sides 110c and 110d to the center of the flexible display panel 110, and when a decrease of the brightness is too great, the user may not properly recognize a part of an image, which is displayed around the center of the flexible display panel 110. Therefore, in such an embodiment, the brightness of the pixels of each area of the flexible display panel 110 is controlled based on a location, a direction and a degree of curvature of the flexible display panel 110 to prevent the brightness difference of the image due to the curvature.

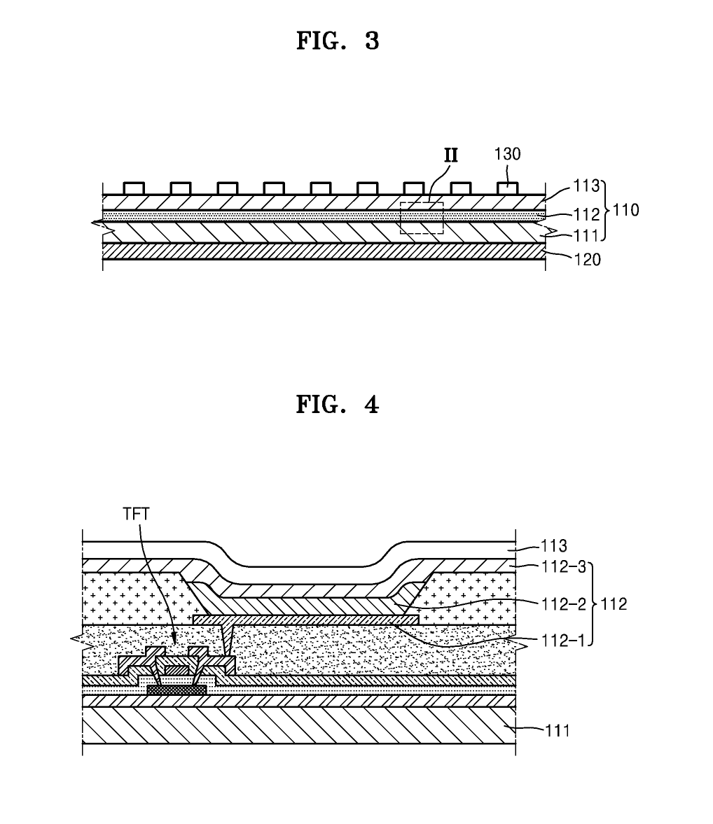

FIG. 3 is a cross-sectional view taken along line I-I′ of FIG. 1A.

Referring to FIG. 3, the flexible display panel 110 includes a first flexible substrate 111, a second flexible substrate 113 disposed opposite to the first flexible substrate 111, and an organic light-emitting device 112 disposed between the first and second flexible substrates 111 and 113.

The first flexible substrate 111 may include or be formed of a plastic material having high heat resistance and durability such as polyoxyethylene etherphthalate, polyethylenenaphthalate, polycarbonate, polyarylate, polyetherimide, polyethersulfone, polyimide, or a combination thereof, for example. However, the material is not limited thereto and may include a variety of materials having flexibility.

The first flexible substrate 111 may further include a barrier layer (not shown). The barrier layer may include an inorganic layer or an organic layer. The barrier layer effectively prevents unnecessary materials from passing through the first flexible substrate 111 and penetrating into the organic light-emitting device 112.

FIG. 4 is an enlarged cross-sectional view of a portion II of FIG. 3.

Referring to FIG. 4, the organic light-emitting device 112 includes a pixel electrode 112-1, an opposite electrode 112-3, which is a common electrode, and an organic light-emitting layer 112-2 disposed therebetween. The pixel electrode 112-1 is electrically connected to a driving thin film transistor (“TFT”) disposed on the first flexible substrate 111. Although not illustrated in FIG. 4, the organic light-emitting device 112 is electrically connected to a switching TFT and a storage capacitor.

The second flexible substrate 113 may disposed on the organic light-emitting device 112 as an encapsulation member for encapsulating the organic light-emitting device 112. The second flexible substrate 113 may include or be formed of the same material as the first flexible substrate 111 or may have a multi-layer structure including an inorganic layer and an organic layer. Although not illustrated in FIGS. 3 and 4, the first and second flexible substrates 111 and 113 may further include a variety of protection members.

The organic light-emitting device 112 is a self-emitting device in which an organic polymer or an organic low molecular compound included in the organic light-emitting layer 112-2 emits light due to a current applied to the pixel electrode 112-2 and the opposite electrode 112-3. In an exemplary embodiment, the display apparatus may include an organic light-emitting device, a flexible LCD, or other type of flexible display panel.

In an exemplary embodiment, where the display apparatus includes the flexible display panel 110 having flexibility, a bent or curved shape of the flexible display panel 110, which allows the user to watch an image with improved quality, may not be maintained. In such an embodiment, a shape deformation unit 120 is disposed on a portion of the flexible display panel 110 to maintain the bent shape of the flexible display panel 110. In an exemplary embodiment, as shown in FIG. 3, the shape deformation unit 120 may be disposed on an opposite side of an area where the image of the flexible display panel 110 is displayed, for example, on the first flexible substrate 111.

The shape deformation unit 120 deforms the shape of the flexible display panel 110 while the mode of the flexible display panel 110 is changed from the PM into the CM. When a reciprocal conversion of the PM and the CM ends, the shape of the flexible display panel 110 is changed and maintained by the shape deformation unit 120 that allows the flexible display panel 110 to be maintained rigid.

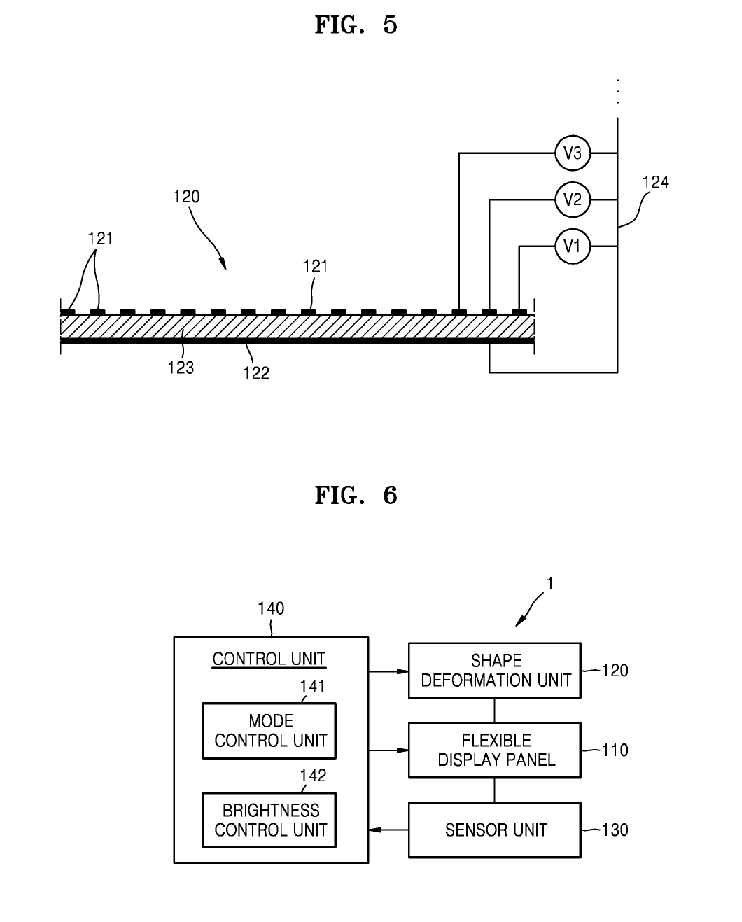

FIG. 5 is an exemplary embodiment of the shape deformation unit 120 of FIG. 3.

Referring to FIG. 5, an exemplary embodiment of the shape deformation unit 120 includes a plurality of first electrodes 121, a second electrode 122, and an actuator 123 disposed between the first electrodes 121 and the second electrode 122.

Each of the first electrodes 121 is arranged substantially parallel to one another on a first surface of the actuator 123 by a predetermined distance, and the second electrode 122 is arranged on a second surface of the actuator 123, which is opposite to the first surface. When predetermined voltages V1, V2 and V3 are applied to each first electrode 121 and the second electrode 122 in a circuit 124 based on a control of a control unit (not shown), the actuator 123 operates in response to the applied voltages V1, V2, and V3. Thus, the degree of curvature of the flexible display panel 110 disposed on a side of the shape deformation unit 120 may be controlled.

In one exemplary embodiment, for example, when a first level voltage V1 is applied, the actuator 123 does not operate, and thus, the flexible display panel 110 remains in the PM. When a second level voltage V2 is applied, the actuator 123 operates, such that the flexible display panel 110 is curved and the mode thereof changes into the CM. When a third level voltage is applied, the actuator 123 does not operate, and the flexible display panel 110 in the CM remains curved. In such an embodiment, the shape deformation unit 120 may function as a shape maintaining unit.

In an exemplary embodiment, the actuator 123 that operates in the first level and the third level voltages V1 and V3 has rigidity and may have flexibility when the actuator 123 operates in the second level voltage V2. In such an embodiment, the first level voltage V1 may be substantially the same as the third level voltage V3. The first through third level voltages V1 through V3 may have predetermined voltage values or may have voltage values in a predetermined range. The actuator 123 may include or be formed of various materials such as electrically response polymers, and shape memory alloys. In such an embodiment, the shape deformation unit 120 may further include a protection film (not shown) that protects the first electrodes 121 and the second electrode 122.

In an exemplary embodiment, the degree of curvature of opposing edges, which are arranged substantially parallel to the center of the flexible display panel 110, may be symmetrically formed by applying the second level voltage V2, which changes the mode of the flexible display panel 110 from the PM to the CM, to the shape deformation unit 120 to gradually increase or decrease the curvature of the flexible display panel 110 from the center of the flexible display panel 110 to the opposing edges thereof.

According to an exemplary embodiment, the shape deformation unit 120 determines whether to apply the PM or the CM based on external force applied to the flexible display panel 110. Accordingly, the first through third voltages may be selectively applied. In one exemplary embodiment, for example, when the user holds and bends the flexible display panel 110, the shape deformation unit 120 determines the CM and applies the second level voltage V2 to the flexible display panel 110. Then, the user bends the flexible display panel 110 to a degree corresponding to the external force and when the external force finishes being applied, the third level voltage V3 is applied such that the flexible display panel 110 may remain in the CM.

According to another exemplary embodiment, the shape deformation unit 120 uses a determination value of the display apparatus and may apply any one of the PM and the CM to the flexible display panel 110 by remote control. In such an embodiment, the shape deformation unit 120 of the display apparatus receives a command from the user and applies the PM or the CM to the flexible display panel 110 even though the external force is not applied to the flexible display panel 110.

In an exemplary embodiment, a sensor unit 130 including a sensor may be disposed on one side of the flexible display panel 110. The sensor unit 130 may measure a degree of shape deformation of the flexible display panel 110, that is, a degree, direction and location of the curvature of the flexible display panel 110.

In such an embodiment, where the flexible display panel 110 has flexibility, the sensor unit 130 may have flexibility to effectively prevent the flexible display panel 110 from being damaged by an impact applied when the flexible display panel 110 is bent. In one exemplary embodiment, for example, the sensor unit 130 is a film type and may have a thickness in a range from several micrometers (μm) to tens of μm. Also, the sensor unit 130 may include or be formed of transparent materials such that a display implemented by the display apparatus 1 is effectively prevented from being influenced.

In an exemplary embodiment, the sensor unit 130 may be disposed on a front surface of the flexible display panel 110. In one exemplary embodiment, for example, the sensor unit 130 may have a multi-layer structure. When the flexible display panel 110 is bent, pressure is applied to the sensor unit 130. The sensor unit 130 may generate electrical signals corresponding to the applied force. In such an embodiment, as the pressure is applied to the sensor unit 130, materials in the sensor unit 130 are arranged in one direction. Thus, the thickness of the sensor unit 130 may be increased or decreased, and an electrical signal may be generated based on the increased or decreased thickness.

In such an embodiment, the pressure applied to the sensor unit 130 changes based on the degree of curvature of the flexible display panel 110, such that the sensor unit 130 may generate sensing information based on values of the applied pressure. The sensing information generated by the sensor unit 130 may be transmitted to the control unit in the form of electrical signals.

In an exemplary embodiment, the sensor unit 130 may include a sensor using a piezo-resistance method. A piezo-film sensor may include or be formed of a material having good electrical properties (e.g., high piezo-resistance properties), such as, carbon nanotube or graphene, for example, but the material is not limited thereto. In an alternative exemplary embodiment, the sensor unit 130 may be a sensor unit using a capacitance method.

In an alternative exemplary embodiment, the sensor unit 130 may be disposed opposite to the first flexible substrate 111 and on the shape deformation unit 120 or may be disposed between the shape deformation unit 120 and the first flexible substrate 111. In such an embodiment, where the display apparatus 1 or 3 may be curved as illustrated in FIGS. 1A and 1C, the sensor unit 130 may be disposed on an entire surface of the flexible display panels 110 and 310. In an exemplary embodiment, where the display apparatus 2 may be folded as illustrated in FIG. 1B, the sensor unit 130 may be disposed around the folding line FL.

FIG. 6 is a schematic block diagram of an exemplary embodiment of the display apparatus 1 according to the invention.

Referring to FIG. 6, an exemplary embodiment of the display apparatus 1 includes the flexible display panel 110, the shape deformation unit 120, the sensor unit 130, and a control unit 140. The control unit 140 includes a mode control unit 141 and a brightness control unit 142, and may convert a mode of the flexible display panel 110 or change the degree of curvature or the brightness of the flexible display panel 110.

As described above, in an exemplary embodiment, the shape deformation unit 120 maintains a plane state or a curved state of the flexible display panel 110, or the shape deformation unit 120 bends the flexible display panel 110. The sensor unit 130 may obtain the location, direction or degree of curvature of the flexible display panel 110.

In an exemplary embodiment, when the external force greater than a certain value is applied to the flexible display panel 110 or the flexible display panel 110 receives an input transmitted by the remote control, the mode control unit 141 applies a voltage having a predetermined level to the shape deformation unit 120 to change an operation state of the shape deformation unit 120 and may reciprocally change the PM and the CM of the flexible display panel 110. In an exemplary embodiment, the mode control unit 141 applies a voltage that changes based on a location of the shape deformation unit 120 and may change the degree of curvature of the flexible display panel 110. According to another exemplary embodiment of the invention, although the mode control unit 141 does not apply a voltage having a predetermined level to the shape deformation unit 120, the flexible display panel 110 may be changed by the external force.

The brightness control unit 142 controls the brightness of the flexible display panel 110 based on the location, direction or degree of the curvature of the flexible display panel 110. The location, direction or degree of the curvature of the flexible display panel 110 may be sensed by the sensor unit 130. The brightness control unit 142 obtains a distance between the user and each area of the flexible display panel 110 and may control areas of the flexible display panel 110, which are far from the user, to have a greater brightness than areas that are close to the user. In an exemplary embodiment, the brightness control unit 142 calculates a distance between the user and each area of the flexible display panel 110 based on the location, direction or degree of the curvature measured by the sensor unit 130 and may control the brightness of each area based on the distance between the user and each area of the flexible display panel 110.

In one exemplary embodiment, for example, when a direction of the curvature of the flexible display panel 110 sensed by the sensor unit 130 is a rear direction (i.e., when the flexible display panel 110 is bent in a direction opposite to the user), the brightness control unit 142 may control the brightness of areas having great curvature to have great brightness, and when a direction of the curvature of the flexible display panel 110 is a front direction, the brightness control unit 142 may control the brightness of areas having great curvature to have small brightness.

Hereinafter, an exemplary embodiment in which the brightness of the flexible display panel 110 is controlled by the brightness control unit 142 will be described in detail.

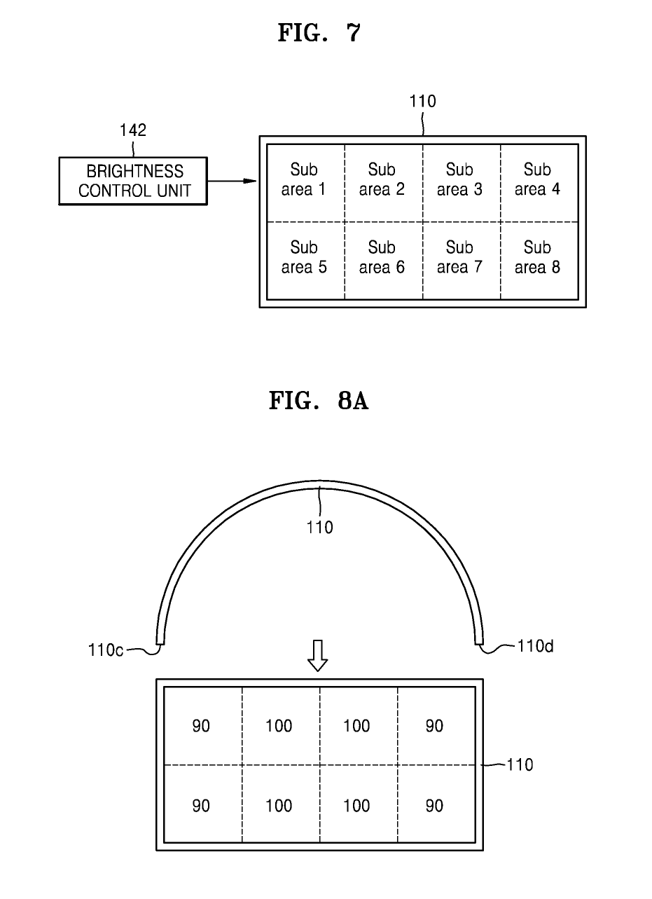

FIG. 7 is a block diagram showing the brightness control of areas of an exemplary embodiment of the flexible display panel 110.

Referring to FIG. 7, the flexible display panel 110 may be divided into a plurality of sub-areas, and the brightness control unit 142 may apply a different brightness to each sub-area of the flexible display panel 110. In one exemplary embodiment, for example, a first sub-area may have a different brightness from a second sub-area. In one exemplary embodiment, as shown in FIG. 7, the brightness control unit 142 divides the flexible display panel 110 into eight sub-areas and controls the brightness of each sub-area, but the invention is not limited thereto. The brightness control unit 142 may divide and control more or less than the eight sub-areas. Alternatively, the brightness control unit 142 may control the brightness of pixels of the flexible display panel 110.

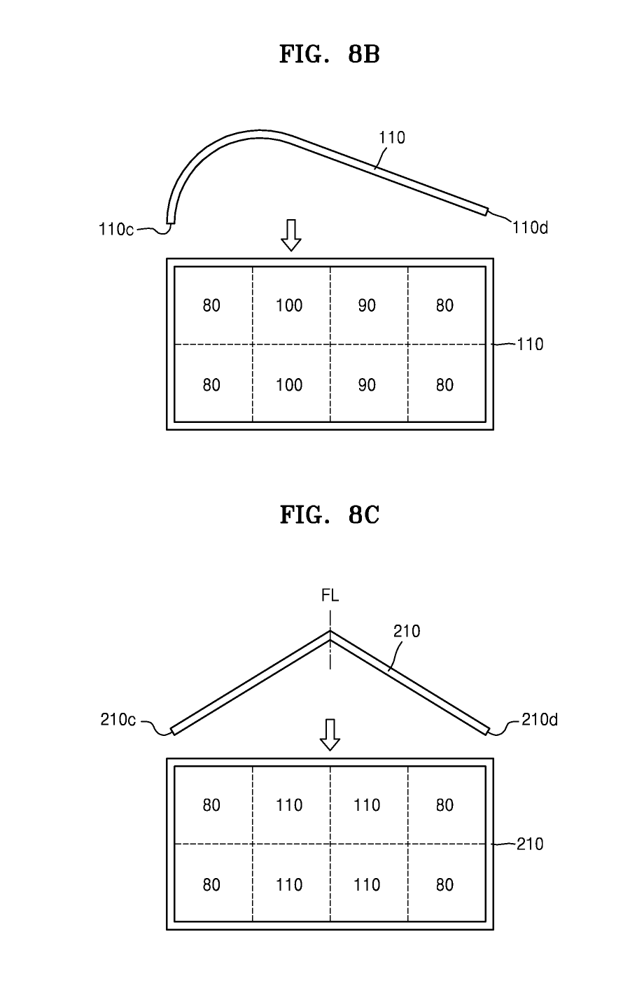

FIGS. 8A through 8C are diagrams showing the brightness control in exemplary embodiments of the flexible display panel 110, according to the invention. In such embodiments, as shown in FIGS. 8A through 8C, pictures above arrows are top views of the flexible display panel 110, and pictures under the arrows are front views illustrating the brightness of each sub-area of the flexible display panel 110. FIGS. 8A through 8C illustrate exemplary embodiments of the flexible display panel 110 bent by the user in a direction away from the user, and the brightness of each sub-area of the flexible display panel 110 illustrated under the arrows of FIGS. 8A through 8C is a relative value.

FIG. 8A shows an exemplary embodiment of the flexible display panel 110, where the first and second short sides 110c and 110d thereof, which are left and right sides of the flexible display panel 110, receives substantially the same force from the user. Referring to FIG. 8A, the curvature of the flexible display panel 110 is substantially symmetrically formed from the center C of the flexible display panel 110. FIG. 8A shows that the brightness of second, third, sixth and seventh sub-areas is ‘100’, and the brightness of first, fourth, fifth and eighth sub-areas is ‘90’. When the flexible display panel 110 is bent as illustrated in FIG. 8A, the second, third, sixth and seventh sub-areas, which are defined in a central portion of the flexible display panel 110, have the greatest curvature and are the farthest from the user. The brightness control unit 142 calculates a distance between the user and each sub-area based on the direction, location or degree of the curvature and may control sub-areas that are far from the user to have the great brightness. In such an embodiment shown in FIG. 8A, visibility of the flexible display panel 110 may be improved by setting the brightness of the second, third, sixth and seventh sub-areas to have greater brightness than remaining sub-areas.

FIG. 8B shows an exemplary embodiment of the flexible display panel 110, where the left side of the flexible display panel 110 thereof, that is, the first short side 110c, receives greater force and is bent more than the right side of the flexible display panel 110. Referring to FIG. 8B, the left side of the flexible display panel 110 is bent more from the center C of the flexible display panel 110 such that an area around the left side of the flexible display panel 110 is the farthest from the user. In such an embodiment, the brightness of the second and sixth sub-areas is set to ‘100’, the brightness of the third and seventh sub-areas is ‘90’, and the brightness of the first, fourth, fifth and eighth sub-areas is ‘80’. According to an exemplary embodiment, when the flexible display panel 110 is asymmetrically curved as illustrated in FIG. 8B, the visibility may be improved by setting the sub-areas having great curvature to have great brightness.

FIG. 8C shows an alternative exemplary embodiment of the flexible display panel 210 that is folded by the user along the folding line FL, as shown in FIG. 1B. Referring to FIG. 8C, the flexible display panel 210 has an angle around the folding line FL. The brightness of the second, third, sixth and seventh sub-areas is ‘110’, and the first, fourth, fifth and eighth sub-areas is ‘80’. When the same amount of force is applied, the flexible display panel 210 that is folded as illustrated in FIG. 8C may have a greater angle than the flexible display panel 110 that is curved, and thus, a degree to which the sub-areas around the folding line FL are far from the user may be greater than the flexible display panel 110 that is curved. Therefore, in such an embodiment, the brightness of the second, third, sixth and seventh sub-areas around the folding line FL may be set to be greater than the brightness of the second, third, sixth and seventh sub-areas of the flexible display panel 110 that is curved.

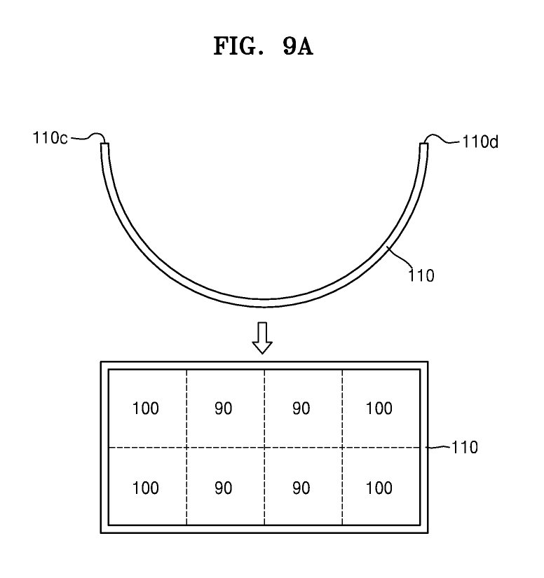

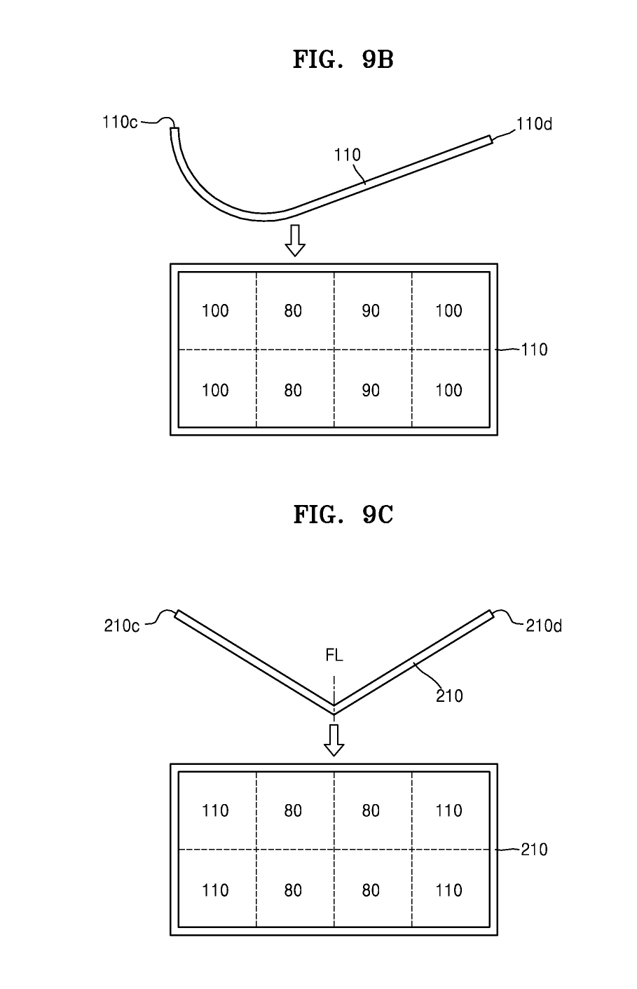

FIGS. 9A through 9C are diagrams showing the brightness control in exemplary embodiments of the flexible display panel 110, according to the invention. FIGS. 9A through 9C show a case where the flexible display panel 110 is curved in a direction toward the user.

FIG. 9A corresponds to FIG. 8A and shows an exemplary embodiment where the user applies the same amount of force to the left and right sides of the flexible display panel 110, that is, the first and second short sides 110c and 110d, and bends the flexible display panel 110 in the direction toward the user. Therefore, left and right edges of the flexible display panel 110 move farther away from the user, and the brightness of sub-areas around the left and right edges may be set to be great to compensate for the movement. In one exemplary embodiment, for example, the brightness of the second, third, sixth and seventh sub-areas may be set as ‘90’, and the brightness of the first, fourth, fifth and eighth sub-areas may be ‘100’, as shown in FIG. 9A.

FIG. 9B corresponds to FIG. 8B and shows an exemplary embodiment where the user applies greater power to the left side of the flexible display panel 110, that is, the first short side 110c and bends the flexible display panel 110 in the direction toward the user. Therefore, the sub-areas arranged on the left side of the flexible display panel 110 are closer to the user. In such an embodiment, the brightness of the second and sixth sub-areas may be ‘80’, the brightness of the third and seventh sub-areas is ‘90’, and the brightness of the first, fourth, fifth and eighth sub-areas may be ‘100’.

FIG. 9C corresponds to FIG. 8C and shows an exemplary embodiment where the user folds the flexible display panel 210 in the direction toward the user along the folding line FL. Therefore, areas of the flexible display panel 210 around the folding line FL become close to the user. In such an embodiment, the brightness of the second, third, sixth and seventh sub-areas may be ‘80’ and the brightness of the first, fourth, fifth and eighth sub-areas may be ‘100’.

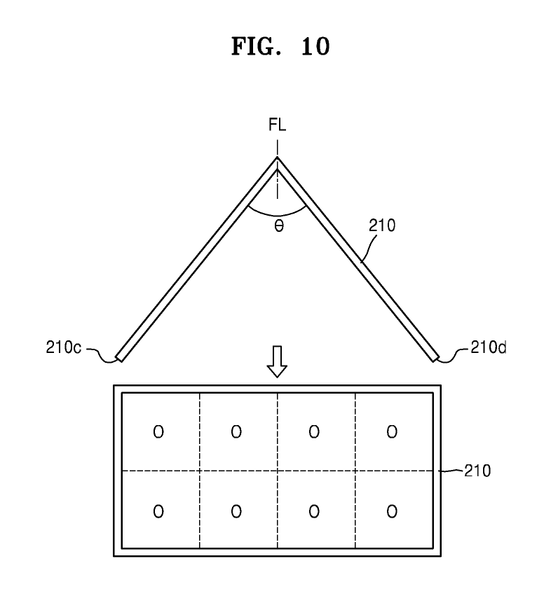

FIG. 10 is a diagram showing the brightness control in an exemplary embodiment of the flexible display panel 210, according to the invention.

Referring to FIG. 10, in an exemplary embodiment, all of the sub-areas of the flexible display panel 210 may have the smallest values of the brightness when an angle θ of the curvature of the flexible display panel 210 is smaller than a predetermined angle. In such an embodiment, when the user folds the flexible display panel 210 to be less than or equal to a predetermined angle 8, the brightness control unit 142 recognizes that the user intends to turn off the flexible display panel 210 and thus may control the entire brightness of the flexible display panel 210 to be the smallest.

In one exemplary embodiment, for example, as illustrated in FIG. 10, when the flexible display panel 210 is folded along the folding line FL and has an angle 8 that is less than or equal to a predetermined angle, the brightness control unit 142 may control all of the sub-areas of the flexible display panel 210 to have ‘0’ brightness.

Although the flexible display panel 210 that is folded is illustrated in FIG. 10, the descriptions of the flexible display panel 210 may be identically applied to the flexible display panel 110. In an exemplary embodiment of the flexible display panel 110 that is curved, the brightness thereof may be the smallest when the curvature of the flexible display panel 110 is equal to or more than a predetermined value.

As described above, according to exemplary embodiments of the invention, a distance difference between a user and each area of a display apparatus, which is caused by the curvature of a flexible display panel, may be compensated by controlling brightness of each area of the display apparatus based on the distance difference.

It should be understood that the exemplary embodiments described herein should be considered in a descriptive sense only and not for purposes of limitation. Descriptions of features or aspects within each embodiment should typically be considered as available for other similar features or aspects in other embodiments.

While one or more exemplary embodiments of the invention have been described with reference to the figures, it will be understood by those of ordinary skill in the art that various changes in form and details may be made therein without departing from the spirit and scope of the invention as defined by the following claims.

What is claimed is:

1. A flexible display apparatus comprising:
a flexible display panel which operates in a plane mode or a curved mode;
a sensor unit which measures a direction, a location or a degree of a curvature of the flexible display panel; and
a brightness control unit which controls brightness of an area of the flexible display panel based on the direction, the location or the degree of the curvature of the flexible display panel.

2. The flexible display apparatus of claim 1, wherein
the brightness control unit obtains a distance between a user and the area of the flexible display panel, and controls brightness of the area of the flexible display panel based on the distance.

3. The flexible display apparatus of claim 1, wherein
the flexible display panel is divided into a plurality of sub-areas, and
the brightness control unit controls the brightness of each of the plurality of sub-areas based on the degree or the direction of the curvature.

4. The flexible display apparatus of claim 1, wherein
when the direction of the curvature of the flexible display panel is a direction away from a user, the brightness control unit increases a brightness of a curved area of the flexible display panel substantially in proportion to the degree of the curvature corresponding to the curved area.

5. The flexible display apparatus of claim 1, wherein
when the direction of the curvature of the flexible display panel is a direction toward a user, the brightness control unit decreases a brightness of a curved area of the flexible display panel substantially in proportion to the degree of the curvature corresponding to the curved area.

6. The flexible display apparatus of claim 5, wherein
the brightness control unit calculates a distance between the user and the area of the flexible display panel based on the direction, the location and the degree of the curvature, and
as the distance between the user and the area of the flexible display panel increases, the brightness control unit decreases the brightness of the area based on calculated distance.

7. The flexible display apparatus of claim 1, wherein
the flexible display panel comprises a curved display panel or a folded display panel.

8. The flexible display apparatus of claim 1, wherein
the flexible display panel comprises a large-sized display panel or a user terminal display panel.

9. The flexible display apparatus of claim 1, wherein
when the flexible display panel curves along a vertical axis, pixels of the flexible display panel arranged on the vertical axis have brightness substantially the same as each other, and
when the flexible display panel curves along a horizontal axis, the pixels of the flexible display panel arranged on the horizontal axis have brightness substantially the same as each other.

10. The flexible display apparatus of claim 1, wherein
a fixed folding line is defined in the flexible display panel, and
a sensor of the sensor unit is disposed in the folding line.

11. The flexible display apparatus of claim 1, wherein
when the degree of the curvature is equal to or greater than a predetermined value, an entire area of the flexible display panel has a minimum brightness.

12. The flexible display apparatus of claim 1, wherein
when the flexible display panel is in the plane mode, an entire area of the flexible display panel has a same brightness.

13. The flexible display apparatus of claim 1, wherein
the flexible display panel comprises a liquid crystal display or an organic light-emitting device.

14. The flexible display apparatus of claim 1, wherein
the sensor unit comprises a sensor, and
the sensor is a transparent and flexible sensor.

15. The flexible display apparatus of claim 1, wherein the flexible display panel is bent by an external force or a remote control.

16. A method of controlling a flexible display apparatus, the method comprising:
bending a flexible display panel using a force or based on a remote control;
measuring a direction, a location or a degree of a curvature of the flexible display panel via a sensor unit; and
controlling brightness of an area of the flexible display panel based on the direction, the location or the degree of the curvature.

17. The method of claim 16, wherein the controlling the brightness comprises:
obtaining a distance between a user and the area of the flexible display panel the direction, the location or the degree of the curvature; and
controlling the brightness of the area of the flexible display panel based on the distance.

18. The method of claim 16, wherein the controlling the brightness comprises:
dividing the flexible display panel into a plurality of sub-areas; and
controlling brightness of each of the plurality of sub-areas based on the degree or the direction of the curvature of the flexible display panel.

19. The method of claim 16, wherein the controlling the brightness comprises increasing brightness of a curved area of the flexible display panel substantially in proportion to the degree of the curvature corresponding to the curved area.

20. The method of claim 16, wherein the controlling the brightness comprises decreasing brightness of a curved area of the flexible display panel substantially in proportion to the degree of the curvature corresponding to the curved area.
